(19) United States
(12) Patent Application Publication
(10) Pub. No.: US 2007/0040021 A1
(43) Pub. Date: Feb. 22, 2007

(54) User identification infrastructure system

(76) Inventor: Keisuke Nakayma, Tokyo (JP)

Correspondence Address: JACOBSON HOLMAN;PROFESSIONAL LIMITED LIABILITY COMPANY, 400 SEVENTH STREET, N.W., WASHINGTON, DC, 20004, US

(21) Appl. No.: 11/590,773

(22) Filed: Nov. 1, 2006

(30) Foreign Application Priority Data
Apr. 26, 2004 (JP) P2004-129537

(51) Int. Cl. G06K 5/00

(52) U.S. Cl. 235/380; 235/382

(57) ABSTRACT

There is disclosed a user identification infrastructure system which does not depend on a user identification device (token) and which sets user identification to be independent of an application (Ap) which requests or uses the user identification and to which Ap-related data can easily be added. A virtual token memory (VETM) service server stores virtual region management information (a user ID, a user access key and/or a user encryption/decryption key, an Ap access key and/or an Ap encryption/decryption key and information of a data file storage place): acquires an Ap ID from a VETM corresponding client by an operation of a VETM corresponding Ap; acquires information of the file storage place based on the user access key and/or the user encryption/decryption key uniquely derived and produced from a user identifier or the like received from the token and the Ap ID; decrypts the information with the Ap encryption/decryption key; and/or accesses the information with the Ap access key.

### BACKGROUND OF THE INVENTION

1. Field of the Invention

The present invention relates to a user identification infrastructure system. More particularly, it relates to a user identification infrastructure system in which especially a physical storage region of a user identification device (hereinafter referred to as the “token”) such as an IC card is efficiently used to secure a virtual storage region and perform user identification, whereby security of the virtual storage region can further be secured.

2. Description of the Related Art

In general, an IC card (smart card in Europe and the United States) is a plastic card in which an IC chip is embedded. The IC card can treat a larger amount of data and has a more excellent security as compared with a magnetic card which is presently broadly used, and therefore the IC card broadly attracts much attention as the card of the next generation.

Especially, the security is remarkably important in an electronic purse (electronic money), electric commerce and the like, and hence the utilization of the IC card is indispensable.

Moreover, an application field of the IC card is not limited to the above field. It has been investigated in, for example, a medical field that the IC card be used as a patient registration card or a resident card in which a medical history, medical treatments, health information and the like are recorded in order to enhance services and rationalize clerical works.

Furthermore, there are not a few corporations which pay attention to the security of the IC card and which are to employ a multifunctional employee ID card provided with private security system (door security system, access management of a network, etc.) functions in the corporations.

In addition, to construct a system of a basic resident register, it has been investigated that resident's basic register information be stored in the IC card.

Thus, an application range of the IC card is much diversified, and it is no exaggeration to say that all applications or systems requiring cards can use the IC cards.

Under such situations, in the IC card, the information is recorded in a nonvolatile memory such as an electrically erasable programmable read-only memory (EEPROM) incorporated in an IC chip, but a memory capacity of the card ranges from a minimum of 200 bytes to a maximum of several tens of kilobytes.

As described above, the utilization field of the IC card broadens and the card has an excellent portability. In view of these advantages, there is demanded enlargement of the capacity of the memory under present situations in which an amount of the information to be stored increases.

On the other hand, in the card (CPU card) in which a microprocessor is incorporated, all accesses to the card memory are managed by the microprocessor. Therefore, it is remarkably difficult to illegally read out the information and tamper with the information. When the CPU card is used, one card can cope with a plurality of applications (use fields). Also in view of this point, further enlargement of the capacity of the memory is demanded.

Here, an example of a data constitution in a memory region of the IC card will be described with reference to FIG. 6. FIG. 6 is an explanatory view showing the example of the data constitution in the memory region of the IC card.

In the IC card, various settings are possible with respect to a constitution of a file and a control of an access to the file. The card is basically constituted of: an IC card CPU, a master file (MF) and a dedicate file (DF) of a plurality of data files (elementary files: EF).

The IC card CPU includes a CPU which executes a processing control in the IC card.

As a prior art related to a memory access control of the IC card, there is Japanese Patent Application Laid-Open No. 2003-16403 “Information Storage Medium, IC Chip including Memory Region, Information Processing Device having IC chip provided with Memory Region and Method of managing Memory of Information Storage Medium”.

In this prior art, a hierarchical structure is introduced into the memory region of the IC card. Accordingly, each application allotted to each memory region is registered in a directory, and the memory region is managed for each directory to efficiently control access rights to each application.

Moreover, as another prior art, there is Japanese Patent Application Laid-Open No. 2003-122646 “IC Card and Method of controlling Access to Memory of IC Card”.

This prior art is an access control method in which during rewriting of the data in the memory of the IC card and garbage collection, mismatch of the memory region is eliminated at a high speed, when a power supply is interrupted during the processing.

Furthermore, as a prior art concerning a memory access control in a fingerprint identification device in which the IC card and the like are used, there is Japanese Patent Application Laid-Open No. 2003-85149 “Fingerprint Identification Device and Identification System”.

This prior art is an identification system in the fingerprint identification device in which the IC card and the like are used. The system encrypts and holds an access key for accessing data in a memory of an IC card portion; performs identification in accordance with a degree of security of an application; decrypts the encrypted access key to permit an access to the data by the decrypted key; and output the data.

As shown in FIG. 7, a system in which a user identification device (token) such as a general IC card is used includes a token 1 in which information such as a user identifier is stored; a communication driver 2a which controls read/write of the information with respect to the token 1; an application (Apa, Apb and Apc) 6′ which performs user identification by use of the token 1 and which requests a data access of a user obtained by the user identification; a client 5′ which performs a request for start of the application 6′; and a server 3′ which accesses the token 1 via the communication driver 2a to operate the application 6′ in response to the start request or the like from the client 5′.

FIG. 7 is a schematic diagram of a user identification system in which a general token is used.

In the above system, the applications (Apa, Apb and Apc) are designed and prepared in accordance with the tokens (a, b and c), and the communication driver 2a is also provided in accordance with each token. That is, the application is designed and prepared depending on each token.

Therefore, owing to the dependence of the application in the above system on the token, the design needs to be changed in a case where the data which can be treated by the application is added later to the memory of the token. As the case may be, the token is recovered to perform an operation, and there has been a problem that development operations and costs increase.

Moreover, when there is not any room for the memory capacity in the token or there is a security problem or the like and data other the user identifier is prohibited from being written in a region, any application-related data cannot be stored in the memory of the token, and the use of the token cannot be extended.

Furthermore, since the application has the dependence on the token, in a case where the application Apa for the token a is to be applied to another token b, the design needs to be largely changed owing to differences in token type and specifications or the like. There has been a problem that the development operations and costs increase.

### SUMMARY OF THE INVENTION

The present invention has been developed in view of the above situations, and an object is to provide a user identification infrastructure system in which a token is treated as a virtual token and which is provided with a virtual extended region obtained by extending a storage region of the virtual token and which operates an application with respect to the virtual token. In consequence, the application does not depend on any token and can be constituted to be independent, and addition of application-related data and applying of the application to various tokens can be facilitated.

The present invention relates to a user identification infrastructure system in which an application operates to perform user identification by use of a user identification device and to request a data access of a user obtained by the user identification, the system comprising: a virtual memory service server which acquires, from a client, a request for start of the application and identification information of the application and which uses the connected user identification device as a virtual user identification device and which provides an extended storage region with respect to the virtual user identification device and which produces a user access key and/or a user encryption/decryption key uniquely derived from user identification information stored in the user identification device and which accesses and reads data of the user stored in a storage place of the extended storage region specified by the user access key and/or the user encryption/decryption key produced and an identifier of the acquired application. The user identification is performed. Moreover, a storage capacity of a token is virtually flexibly enlarged. The token is associated with the data stored in the extended storage region for each user and each application. Accordingly, the token can be treated as a virtual token, the application holds its independency without depending on the individual tokens, and a firewall can be formed for each application to secure security.

In the user identification infrastructure system of the present invention, the virtual memory service server includes a virtual user identification device driver in which a security level of the user identification is beforehand set to perform the user identification. The independency of the user identification can be retained.

In the user identification infrastructure system of the present invention, the virtual user identification device driver performs the user identification by a combination of a plurality of user identification devices, and a security level can be enhanced.

In the user identification infrastructure system of the present invention, a virtual user identification device memory database is provided as the extended storage region, and extended information can be scattered and managed.

In the user identification infrastructure system of the present invention, the virtual memory service server exclusively controls processing of a plurality of applications, and the plurality of application can be used without any delay.

In the user identification infrastructure system of the present invention, the virtual memory service server monitors an attached state of the user identification device, and erases the read data, when it is detected that the user identification device is brought into a non-attached state, and security can be enhanced.

In the user identification infrastructure system of the present invention, the virtual memory service server includes a storage unit in which a user identifier, the user access key and/or the user encryption/decryption key uniquely derived from the user identification information stored in the user identification device, the identifier of the application for use, an application access key and/or an application encryption/decryption key for each application and information of the storage place of related data in the extended storage region are associated with one another and stored. The related data stored in the extended storage region is encrypted with the application encryption/decryption key, and/or accessed with the application access key and stored. When the user identification device is brought into an attached state, the virtual memory service server produces the user access key and/or the user encryption/decryption key uniquely derived from the user identification information stored in the user identification device; acquires information of the storage place of the related data in the extended storage region based on the user access key and/or the user encryption/decryption key produced and the identifier of the application acquired from the client; reads the related data in accordance with the information of the storage place; decrypts the related data with the corresponding application encryption/decryption key; and/or accesses the related data with the corresponding application access key. Since the encrypted related data is decrypted with the application key to be usable by the application, the security can be enhanced.

In the user identification infrastructure system of the present invention, data of biological identification is encrypted and stored in the storage place of the extended storage region. The virtual memory service server reads out the data of the biological identification to decrypt the data, and compares the data with input data of the biological identification to perform the biological identification. Even when the token is not provided with a region to store the data of the biological identification, the biological identification can be realized.

According to the present invention, the user is identified by what a token such as the IC card now has (something you have) and that the user known a password (something you know). In addition, biological identification data such as a fingerprint and a face form (something you are) and signature (something you do) is added as virtual region management information to the virtual storage region. In consequence, a multi-element identification system can flexibly and inexpensively be constructed in early stages.

### BRIEF DESCRIPTION OF THE DRAWINGS

FIG. 1 is a schematic diagram of an identification infrastructure system in an embodiment of the present invention;

FIG. 2 is a constitution block diagram of an identification infrastructure system in which a cellular phone is used in an embodiment of the present invention;

FIG. 3 is a schematic diagram of a virtual token memory service server of an identification system in an embodiment of the present invention;

FIG. 4 is a flow chart showing processing in a virtual token memory service server 3 of an identification system in an embodiment of the present invention;

FIG. 5 is a constitution block diagram of an identification infrastructure system including an extended storage region usable for an IC card in a memory of which data is prohibited from being written;

FIG. 6 is an explanatory view showing an example of a data constitution in a memory region of an IC card; and

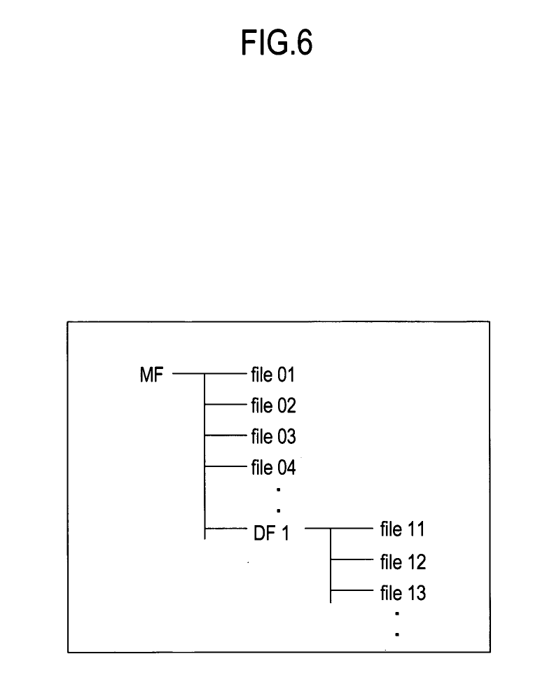

FIG. 7 is a schematic diagram of an identification infrastructure system in which a general token is used.

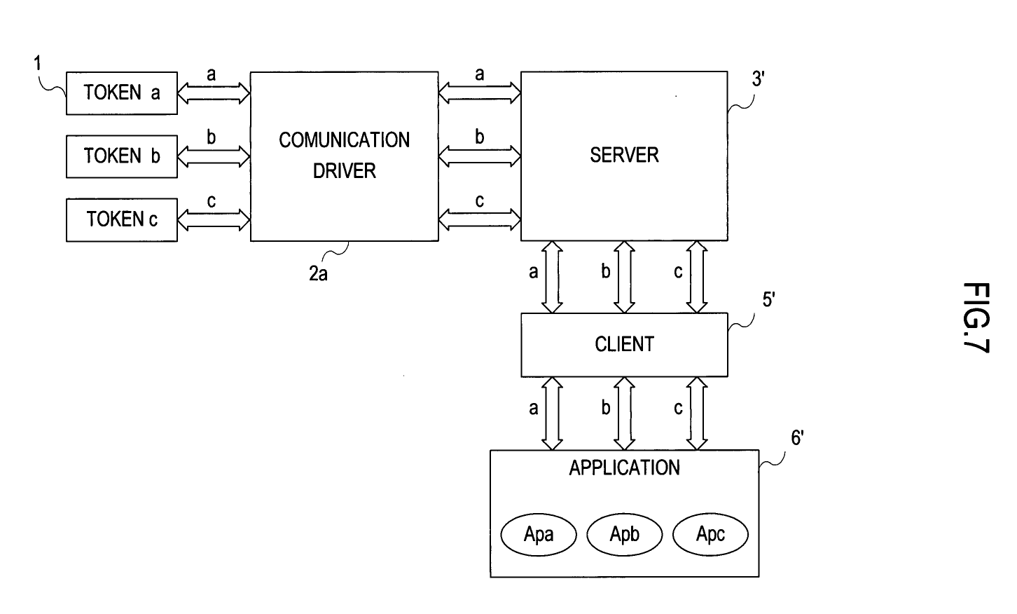

### DESCRIPTION OF REFERENCE NUMERALS

1 . . . token, 1′ . . . IC card, 2 . . . driver, 2a . . . token communication driver, 2b . . . virtual token driver, 3 . . . virtual token memory service server, 3′ . . . server, 4 . . . virtual token memory database, 5 . . . virtual token memory corresponding client, 5′ . . . client, 6 . . . virtual token memory corresponding application, 6′ . . . application, 10 . . . cellular phone, 20 . . . PC, 30 . . . IC card reader/writer

### DESCRIPTION OF THE PREFERRED EMBODIMENT

An embodiment of the present invention will be described with reference to the drawings.

Here, a user identification device is a device including an internal memory in which user identification information is stored and having a part or all of a function of identifying a user. Examples of the device provided with a CPU include an IC card, and examples of the device which is not provided with any CPU include a semiconductor memory such as a USB memory. The user identification device will hereinafter be referred to as the “token”.

In a user identification infrastructure system of an embodiment of the present invention, with respect to an application in which user identification is performed using the user identification device and which requests an access to data of a user obtained by the user identification, there are provided a virtual token driver capable of treating various connected tokens as virtual tokens to identify the user; and an extended storage region of each virtual token. In order to connect the virtual token to the extended storage region, a virtual token memory service server makes it possible to access related data stored for each application by use of a user access key and/or a user encryption/decryption key uniquely derived from a user identifier in the token and an application ID. Accordingly, the application can be operated in accordance with the virtual token. In consequence, the application has independency without depending on the token. Therefore, the application does not have to be designed and prepared for each token. When application-related data is further added, an operation is facilitated, and development costs can be reduced.

Moreover, if the virtual token driver determines a security level by a combination of the tokens, a security level can be enhanced. For example, a token which performs PIN identification can be combined with a token which performs biological identification to construct a firmer system.

The user identification infrastructure system in the embodiment of the present invention produces the user access key and/or the user encryption/decryption key uniquely derived from the identifier or the identification information which is stored in the memory of a token such as the IC card and which is to specify the user; acquires an access key (application access key) or an encryption/decryption key (application encryption/decryption key) which makes it possible to use the application and information of a storage place of a file based on the user access key and/or the user encryption/decryption key produced and the application ID; decrypts the file stored in a virtual region indicated by the information of the storage place of the file with the application encryption/decryption key; and/or accesses the file with the application access key, whereby the file is set to be usable. The system performs the user identification, and secures the virtual region. When the application ID is used as an index, a firewall can be formed for each application to secure a security.

Here, in the storage place of the file, the data (file) to be used by the application is encrypted with the application encryption/decryption key and stored, and/or the data is stored so as to be accessible with the application access key.

Moreover, the data encrypted with the application encryption/decryption key may further be encrypted with the user encryption/decryption key when stored. The encrypting with the user encryption/decryption key may be performed multiple times such as doubly or triply.

It is to be noted that there is not any special restriction on an encryption system, a public key is preferable, but another system such as a common key may be used.

Furthermore, in the user identification infrastructure system of the embodiment of the present invention, a server which offers a virtual memory of the token accesses the file to be used by the application with the access key (application access key) for each application; and/or encrypts the file with the encryption/decryption key (application encryption/decryption key); and associates, with a user ID, the information of the storage place of the file, the application ID, information of the application access key and/or the application encryption/decryption key and information of the user access key and/or the user encryption/decryption key for accessing the above information to store the them. When the application accesses the file, the server acquires the information of the file storage place by use of the user access key and/or the user encryption/decryption key uniquely derived and produced from the user identifier or the like stored in the token and the application ID; decrypts data stored in the file storage place with the application encryption/decryption key corresponding to the application ID; and/or accesses the data with the application access key to make it possible to use the data by the application. When the usable file is updated, the server encrypts the data with the application encryption/decryption key and/or sets the file to be accessible with the application access key to store the file in the file storage place. The user identification is performed, and the data stored in the file storage place constituting a virtual storage region by use of the application ID as an index is set to be accessible by use of the user access key and/or the user encryption/decryption key uniquely derived from the user identifier or the like stored in the token. Therefore, the firewall can be formed for each application to secure the security.

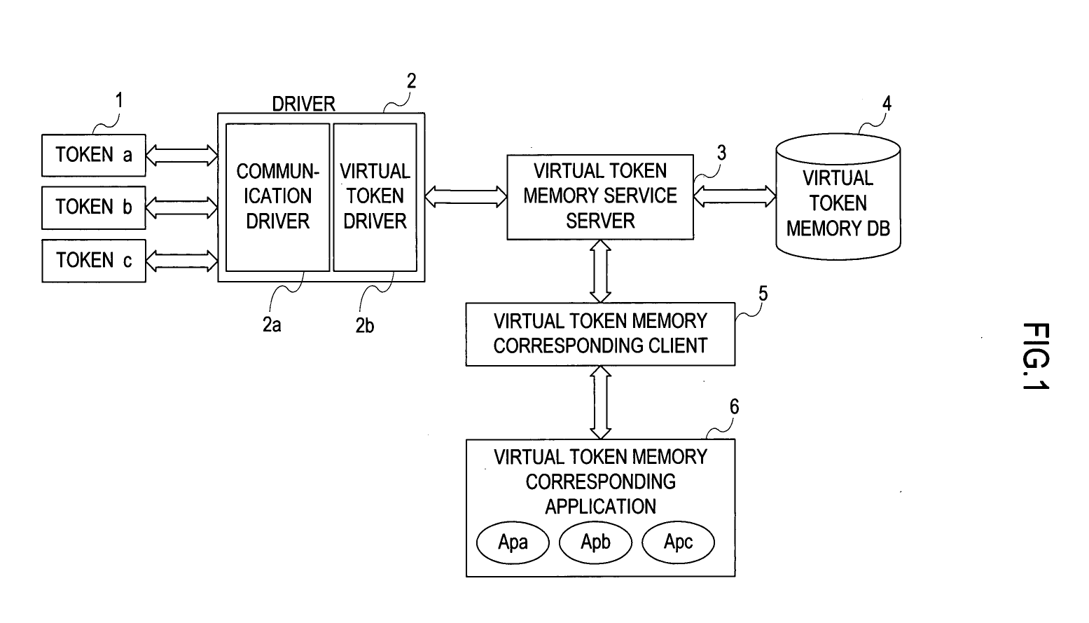

First, there will be described an outline of a user identification infrastructure system in an embodiment of the present invention with reference to FIG. 1. FIG. 1 is a schematic diagram of the user identification infrastructure system in the embodiment of the present invention.

As shown in FIG. 1, the user identification infrastructure system (the present system) in the embodiment of the present invention is basically constituted of a token 1 as an external storage device; a driver 2 which controls input/output of the token 1; a virtual token memory service server (virtual extended token memory server: VETM server) 3 which provides a service of a virtual token memory; a virtual token memory database (virtual extended token memory database: VETM database or the virtual token memory DB) 4 which is a virtual token memory; a virtual token memory corresponding client (virtual extended token memory client: VETM client) 5 which corresponds to the virtual token memory and which receives the service from the VETM server 3; and a virtual token memory corresponding application (VETM application) 6 which executes various functions in accordance with the service of the virtual token memory via the VETM client 5.

Here, the VETM server 3 has a function of providing the service of the virtual token memory, the VETM client 5 has a function of requiring the service provided by the VETM server 3, and the VETM application 6 is an application which can be realized by the service of the virtual token memory.

Each component of the present system of FIG. 1 will be described specifically.

The token 1 is a user identification virtual token by the external storage device in which there is stored a system identifier (user ID), an electronic certificate or the like for specifying the user. Examples of the token including a central processing unit (CPU) and a memory include a contact or non-contact IC card and a fingerprint identification token. Examples of the token including the only memory without including any CPU include a magnetic disk capable of storing the user ID and the like, a universal serial bus (USB) memory and another semiconductor memory.

In FIG. 1, for example, three types of tokens are shown as tokens a, b and c. In the present embodiment, these tokens are treated as the virtual tokens.

Moreover, since a plurality of tokens are combined for use in user identification, a security level can be enhanced.

The driver 2 is constituted of a communication driver 2a and a virtual token driver 2b.

The communication driver 2a is a standard driver which copes with any type of token 1, and a driver which controls an actual access to the token 1.

The virtual token driver 2b is a driver which controls the input/output with respect to the VETM server 3. The driver is especially used in realizing the user identification between the user identification virtual token of the token 1 and the VETM server 3.

It is to be noted that the virtual token driver 2b needs to be provided in accordance with the communication driver 2a, and the driver has a function capable of reading information such as the user identifier from the token 1 and outputting the information to the virtual token memory server 3 to treat the token 1 as the virtual token, when the user identification is performed by the input of a personal identification number (PIN) or the like.

The virtual token memory service server (VETM server) 3 is a server which offers a component function to the VETM client 5 to manage the component function.

Moreover, the VETM server 3 manages information of a data (file) storage place of application-related data stored in the virtual token memory DB 4; an application access key and/or an application encryption/decryption key for decrypting the stored data; and an user access key and/or a user encryption/decryption key for accessing the information of the storage place of the file and an application key.

That is, in the VETM server 3, there are stored the information of the place where the data is stored; the application access key and/or the application encryption/decryption key for accessing and/or encrypting or decrypting the data by the application; and information of a user access key for accessing the information and/or information of a user encryption/decryption key for encrypting or decrypting the information. They are associated with one another when stored.

Various functions to be realized by the VETM server 3 will be described.

Examples of the functions to be realized by the VETM server 3 include a VETM automatic acquiring function; an identical VETM connected state monitoring function; a VETM connected state monitoring function; a VETM client setting function; a code identifying function; a log management setting function; a log output function; a user identifying function; a VETM database connecting function; and a VETM database access function. The above functions can be realized, when control means of the present system starts a program to realize the functions.

The virtual extended token memory (VETM) automatic acquiring function is a function of automatically acquiring a type of the token 1 being connected and system information.

The identical VETM connected state monitoring function is a function of monitoring whether or not the first connected token 1 is continuously connected to acquire a state of the token.

The VETM connected state monitoring function is a function of monitoring whether or not a system environment (interface, port, etc.) to be used by the first connected token 1 has been changed to acquire a state of the environment.

The VETM client setting function is a function of setting each function of the application to be effective or ineffective.

The code identifying function is a function of checking whether or not a source of a module of the client is valid in a case where the VETM client 5 requests the service.

The log management setting function is a function of setting a log output method or the like concerning a processing result of the service requested by the VETM client 5.

The log output function is a function of outputting the processing result as a log in a case where the VETM client 5 requests the service.

The user identifying function is a function of acquiring a result of the user identification in the token 1. As the results, Boolean type, a judgment value, a score value and an update date are used.

The VETM database connecting function is a function of acquiring a systematic location (a drive including a network, a folder, a VETM database name) and an access system of the virtual token memory DB (VETM database) 4.

The VETM database access function is a function of accessing the VETM database 4, and the function is finely divided into functions of additional registration, update, delete, read and database copy.

The virtual token memory DB 4 is a data storage device which realizes a virtual memory of the token 1. In the memory, application-related data is stored in accordance with the user ID or the like of the token 1.

The virtual storage region of the token offered by this virtual token memory DB 4 can make it easy to perform addition of the related data and the like. Therefore, the virtual storage region can correspond to the virtual token independently of each token 1.

It is to be noted that the virtual token memory DB 4 may be scattered.

Details of the virtual token memory DB 4 will be described later.

The virtual token memory corresponding client (VETM client) 5 is a client which requests the virtual token memory service server (VETM server) 3 to provide the service.

Various requests of the VETM client 5 to the VETM server 3 include a VETM service start request, a user identification request, a VETM database access request and a log output request.

In the VETM service start request, an application ID is transmitted to the VETM server 3. If the application is permitted, a code identification request is made. A result and access method of the identification are acquired.

The virtual token memory corresponding application (VETM application) 6 is an application (hereinafter sometimes abbreviated as “Ap”) which performs the user identification by use of the token 1 (user identification device) and which requests an access to user's data obtained by the user identification. The application becomes executable, when the application-related data stored in the virtual token memory DB 4 is accessed using the virtual token memory service provided from the VETM server 3.

It is to be noted that the VETM application 6 outputs the application ID in a case where the VETM client 5 makes the service start request.

Examples of the application include automatic log-on, automatic log-off, automatic decrypting, automatic encrypting, group encrypting and group decrypting. These applications are executed with respect to the virtual token. Therefore, the application does not depend on each token 1, and is independent of each token 1.

Next, an operation of the present system will be described.

In a case where the virtual token memory corresponding application 6 is used, when there is an access from the VETM client 5 to request the user start, the VETM server 3 monitors a connected state of the token 1 (e.g., the IC card). This monitoring is constantly performed. If the token 1 is not attached, a message which urges the client to attach the token is output to the VETM client 5. If the attached token 1 is extracted or taken out, this state is detected, and the user ID, the application-related data and the like read from the token 1 are immediately erased to end the processing.

Moreover, the VETM server 3 specifies a storage place (file storage place) of the data to be used by the virtual token memory corresponding application 6 in response to an instruction from the VETM client 5, and associates, with the user ID, information of the file storage place; the application ID; information of the application access key to access the file and/or the application encryption/decryption key to encrypt or decrypt the file; and information of the user access key for accessing the above information and/or the user encryption/decryption key to encrypt or decrypt the information to store them.

It is to be noted that an object of the file storage place may be a field, a file, a folder or a drive.

Moreover, the VETM server 3 uniquely derives and produces, from the user identifier or the like stored in the token 1, the user access key and/or the user encryption/decryption key for accessing the data to be used by the virtual token memory corresponding application 6; acquires user-related information by use of the user access key and/or the user encryption/decryption key; acquires the information of the file storage place of the corresponding application by use of the application ID input from the application as an index via the VETM client 5; further decrypts the data stored in the file storage place with corresponding application encryption/decryption key corresponding to the application ID; and/or accesses the data stored in the file storage place with the application access key to make it possible to use the data in the virtual token memory corresponding application 6.

Furthermore, the VETM server 3 encrypts the data used and updated by the virtual token memory corresponding application 6 with the application encryption/decryption key, and/or sets the data to be accessible with the application access key to store the data in the file storage place.

It is to be noted that when the user encryption/decryption key is used instead of the user access key, the data stored in the file storage place is encrypted with the application encryption/decryption key, and/or set to be accessible with the application access key, and further encrypted with the user encryption/decryption key. When the data is accessed by the application, data of the file storage place is decrypted with the user encryption/decryption key, further decrypted with the application encryption/decryption key, and/or accessed with the application access key.

Moreover, the information of the application ID, the application encryption/decryption key and the file storage place are beforehand encrypted with the user encryption/decryption key. When the data is accessed by the application, information such as the application ID is decrypted with the user encryption/decryption key, further the data of the file storage place is decrypted with the application encryption/decryption key, and/or the data may be accessed with the application access key.

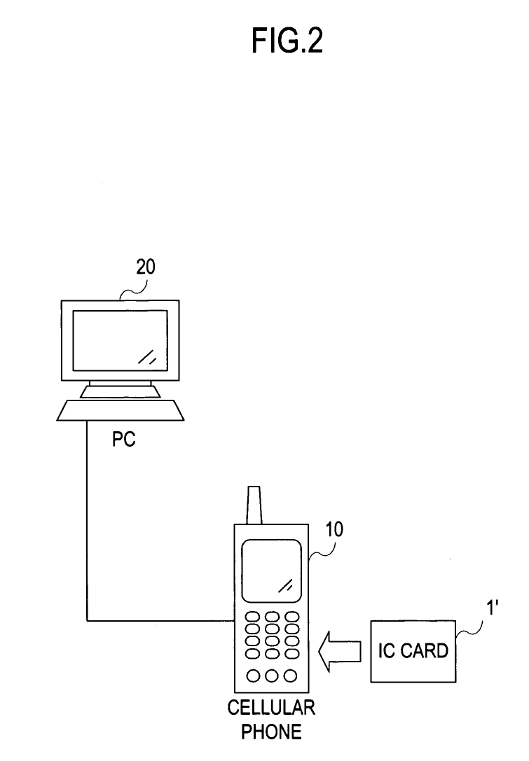

Next, there will be described a basic device constitution of a user identification infrastructure system in an embodiment of the present invention with reference to FIG. 2. FIG. 2 is a constitution block diagram of the user identification infrastructure system in which a cellular phone is used in the embodiment of the present invention.

In the user identification infrastructure system in which the cellular phone is used, a constitution is presumed in which a small IC card chip is incorporated in the cellular phone. As shown in FIG. 2, the system is constituted of an IC card 1′; a cellular phone 10 in which the IC card 1′ is to be incorporated; and a computer (PC) 20 connected to the cellular phone 10 by a cable.

In FIG. 2, the PC 20 realizes the driver 2, the VETM server 3, the virtual token memory DB 4, the VETM client 5 and the VETM application 6 of FIG. 1.

The components shown in FIG. 2 will be described specifically.

The IC card 1′ is an IC card basically having an IC chip. The IC chip has a central processing unit (CPU) which analyzes an input signal from the outside and which executes processing to output a result to the outside; a read only memory (ROM) in which an operating system (OS), the application and the like are stored; a random access memory (RAM) which is a memory for an operation; and a nonvolatile memory (EEPROM: electronically erasable and programmable read only memory) in which user data is stored.

It is to be noted that there is a chip in which a flash memory is employed instead of the EEPROM. The application is stored in the EEPROM in some case.

Here, examples of the user data (user identifier) include an identifier or identification information stored in the electronic certificate or the like, but a specific identifier (the only one identifier in the system) for identifying the user may be used.

The cellular phone 10 includes a control unit (CPU) which performs a control; an ROM in which a processing program is stored; an RAM which is a memory for the operation; a nonvolatile memory (EEPROM) in which the user data is stored; a display unit; an input unit such as keys; a communication unit which performs communication; and an attaching portion to which the IC card 1′ is to be attached.

It is to be noted that when the IC card 1′ is attached to the attaching portion, the cellular phone 10 can read data (here, for example, the “identifier stored in the electronic certificate or the like”) stored in the nonvolatile memory of the IC card 1′.

This identifier stored in the electronic certificate or the like is a “user identifier” which identifies the user of the cellular phone 10, and includes identification information such as a number or the like managed by a distributor of the IC card.

The PC 20 includes a control unit (CPU) which performs a control; a storage unit such as a hard disk (HDD) in which a processing program and user data are stored; an RAM which is a main memory for the operation; a display unit; an input unit such as a keyboard or a mouse; a communication unit which performs communication; and a connecting portion (interface) to be connected to the cellular phone 10.

The storage unit will be described in accordance with an example of the hard disk drive (HDD), but there may be considered a floppy (registered trademark) disk drive (FDD), a magneto optical disk (MO), a removable disk, a nonvolatile memory card or the like.

Moreover, the PC 20 includes the communication unit, and may be constituted to be connected to a modem and a public circuit, a LAN, a radio LAN board and the LAN, or a network such as a WAN or Bluetooth (registered trademark).

It is to be noted that when the PC 20 is connected to the cellular phone 10, the PC can read the data (e.g., the identifier stored in the electronic certificate or the like) stored in the nonvolatile memory of the IC card 1′ attached to the cellular phone 10.

In FIG. 2, the token of the IC card 1′ is connected to the PC 20 by a cable via the cellular phone 10, but the IC card 1′ may be connected to the PC 20 by radio.

The control unit of the PC 20 loads the main memory with the program (application) to operate the virtual token memory corresponding application 6 in a case where the application is executed. In a case where the data stored in the storage unit is used, when, for example, a request for issuance of the electronic certificate or the like is made as the operation of the virtual token memory corresponding client 5, an ID (the identifier for identification) and a password for the identification are input to perform the user identification as the operation of the virtual token memory service server 3. If the password is appropriate with respect to the ID for identification, the user identification becomes OK. The identifier stored in the electronic certificate or the like of the IC card 1′ is acquired, and the user access key and/or the user encryption/decryption key uniquely derived from the identifier of the user is produced.

It is to be noted that in the user identification, a PIN such as the password may be used, but biological identification may be performed using a fingerprint, a voice pattern, an eye iris or retina, a face image, a blood flow or the like. In this case, each device for the biological identification needs to be mounted on the cellular phone 10 or the PC 20.

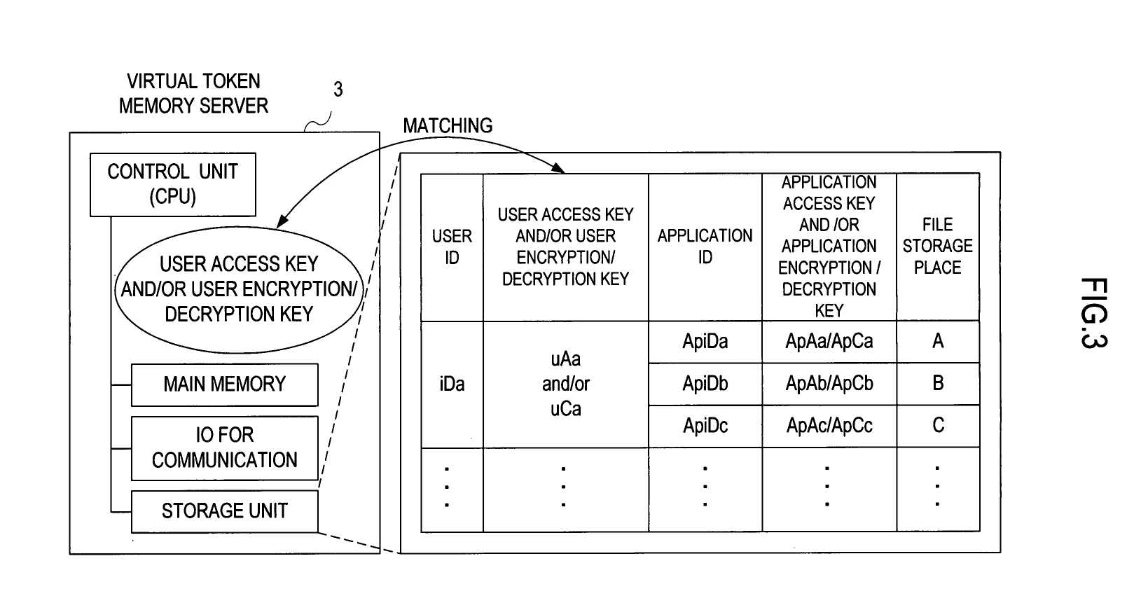

Next, there will be described the virtual token memory service server 3 realized in the PC 20 with reference to FIG. 3. FIG. 3 is a schematic diagram of the virtual token memory service server of a user identification system in an embodiment of the present invention.

The virtual token memory service server 3 includes a control unit (CPU) which performs a control, a main memory which allows a program or the like to be executed, and a storage unit in which data and the like are stored in the same manner as in the hardware constitution of the PC 20. Additionally, the server may include an input/output interface for communication (IO for communication) to be connected to the network.

Furthermore, the virtual token memory service server 3 includes an interface to be connected to the virtual token memory DB 4, and is connected to the virtual token memory DB 4. The control unit of the virtual token memory service server 3 accesses the virtual token memory DB 4.

The control unit of the virtual token memory service server 3 judges whether or not the user access key and/or the user encryption/decryption key uniquely derived and produced from the user identifier match the user access key and/or the user encryption/decryption key beforehand stored in the storage unit.

When the user access keys and/or the user encryption/decryption keys match with each other, the control unit of the virtual token memory service server 3 then acquires, from the storage unit, the corresponding application access key and/or application encryption/decryption key and virtual region management information of the file storage place by use of the application ID input from the application as the index, and the control unit accesses an extended storage region of the virtual token memory DB 4 indicated by the virtual region management information of the file storage place.

For example, when the user access key is used, the information stored in the extended storage region of the virtual token memory DB 4 is decrypted with the application encryption/decryption key, and/or accessed with the application access key. When the user encryption/decryption key is used, the information stored in the extended storage region of the virtual token memory DB 4 is decrypted with the user encryption/decryption key, further decrypted with the application encryption/decryption key, and/or accessed with the application access key.

There will be described later specific processing in the control unit of the virtual token memory service server 3.

The virtual token memory service server 3 stores the user ID and the user access key and/or the user encryption/decryption key as the user-related information with respect to the extended storage region, and further stores a plurality of sets of the application IDs, the application access keys and/or the application encryption/decryption keys and the information of the file storage place in accordance with the user access key and/or the user encryption/decryption key. Here, the user ID, the user access key and/or the user encryption/decryption key, the application access key and/or the application encryption/decryption key and the information of the file storage place for use in accessing the extended storage region will be referred to as the “virtual region management information”.

It is to be noted that as shown in FIG. 3, in the virtual token memory service server 3, one user (user ID: iDa) is associated with the user access key (uAa) and/or the user encryption/decryption key (uCa). The user is associated with three application IDs (ApiDa, ApiDb and ApiDc), the application IDs are associated with the application access keys (ApAa, ApAb and ApAc) and/or the application encryption/decryption keys (ApCa, ApCb and ApCc) and further the information (A, B and C) of the file storage place, respectively.

The virtual token memory DB 4 is a storage unit in which there is formed an extended storage region of the user identification infrastructure system in the embodiment of the present invention, and a region of the virtual token memory DB 4 designated by the file storage place is an extended storage region.

Next, there will be described a setting operation in the user identification infrastructure system of the embodiment of the present invention.

As an operation of the virtual token memory corresponding client 5, the PC 20 connected to the cellular phone 10 outputs, for example, the request for the issuance of the electronic certificate or the like to the IC card 1′, and inputs required PIN information. As an operation of the virtual token memory service server 3, the PC performs the user identification, acquires the identifier stored in the electronic certificate or the like, and produces the user access key and/or the user encryption/decryption key uniquely derived from the identifier.

The virtual token memory service server 3 realized in the PC 20 encrypts the data to be used in the virtual token memory corresponding application 6 with the application encryption/decryption key, and/or accesses the data to be used with the application access key and stores the data in the specific region (file storage place) of the virtual token memory DB 4. The server further may encrypt the encrypted data, and/or access the encrypted data with the user access key. Moreover, the virtual token memory service server 3 associates, with each user, the user ID, the user access key and/or the user encryption/decryption key; associates, with each application corresponding to the user, the application ID, the application access key and/or the application encryption/decryption key and the information of the file storage place to store them.

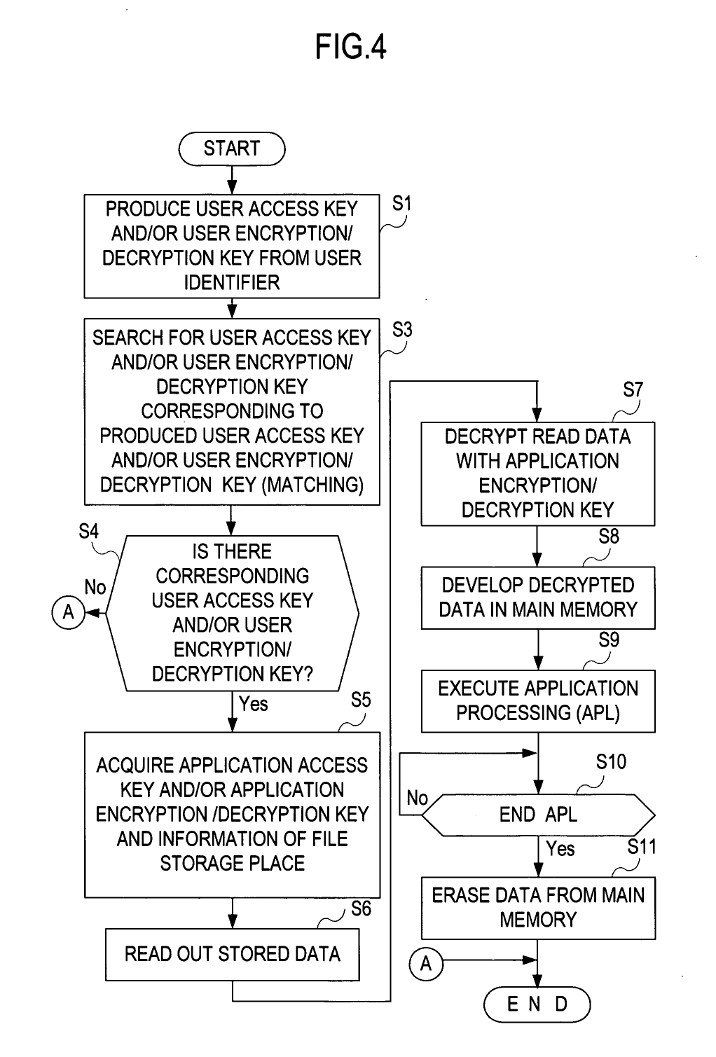

Next, there will be described a processing operation of the user identification infrastructure system in the embodiment of the present invention with reference to FIG. 4. FIG. 4 is a flow chart showing processing in the virtual token memory service server 3 of the user identification infrastructure system in the embodiment of the present invention. It is to be noted that the processing of FIG. 4 is realized by the control unit.

First, to operate the virtual token memory corresponding application 6 in the PC 20, the virtual token memory corresponding client 5 requests the virtual token memory service server 3 to start the service, and the virtual token memory service server 3 acquires the application ID from the virtual token memory corresponding application 6.

For example, the issuance of the electronic certificate or the like is requested. In response to the request, input of information for identification is requested for the user identification, and the user identification is performed by the PIN identification or the biological identification. When the identification is OK, the identifier stored in the electronic certificate or the like of the IC card 1′ is acquired to produce the user access key and/or the user encryption/decryption key uniquely derived from the identifier (user identifier).

In the PC 20, as shown in FIG. 4, the virtual token memory service server 3 produces the user access key and/or the user encryption/decryption key uniquely derived from the user identifier (S1), and performs match processing to search for the user access key and/or the user encryption/decryption key corresponding to the user access key and/or the user encryption/decryption key (S3).

As a result of the match processing S3, the server judges whether or not there is the corresponding user access key and/or user encryption/decryption key in the storage unit of the virtual token memory service server 3 (S4), and ends the processing, if there is not any corresponding user access key and/or user encryption/decryption key (if the answer to the step is No).

It is to be noted that without performing the judgment processing S4, during the user identification, it may be judged in advance whether or not there is the user ID corresponding to the user in the storage unit.

Moreover, when there is the corresponding user access key and/or the user encryption/decryption key (in a case where the answer to the step is Yes), the server acquires the user-related information corresponding to the user access key and/or the user encryption/decryption key from the storage unit, and acquires the application access key and/or the application encryption/decryption key and the information of the file storage place corresponding to the application ID input from the virtual token memory corresponding client 5 (S5).

Moreover, the virtual token memory service server 3 accesses the extended storage region of the virtual token memory DB 4 from the acquired information of the file storage place (a field, a file, a directory, a device or the like of the virtual token memory DB 4), and reads out the stored data (S6). Furthermore, the server decrypts the read data with the application encryption/decryption key (S7), and performs processing to develop the decrypted data in the main memory (SB). It is to be noted that the data decrypted with the application encryption/decryption key may further be decrypted with the user encryption/decryption key.

In the processing S7, there has been described the case where the data is decrypted with the application encryption/decryption key, but the data may be accessed with the application access key. The data may be accessed with the application access key, and the accessed data may be decrypted with the application encryption/decryption key.

Next, in the virtual token memory service server 3, application processing (APL) is executed such as referring or updating of the data by the operation of the virtual token memory corresponding application 6 (S9). When the application processing (APL) ends (if the answer is Yes), the virtual token memory service server 3 performs processing to erase the data from the main memory (S1), and ends the processing.

It is to be noted that if the data is updated in the application processing (APL), the data is encrypted with the corresponding application encryption/decryption key, and/or set to be accessible with the application access key to store the data in an address indicated by the information of the file storage place.

Here, processing of the virtual token memory service server 3 will be described more specifically.

On receiving a request for starting use of the service from the virtual token memory corresponding client 5 which is to use the virtual token memory corresponding application 6, the virtual token memory service server 3 acquires the application ID, and monitors a connected state of the user identification device (IC card 1′). This monitoring is constantly performed. If the IC card 1′ is not attached, the message urging that the card be attached is displayed in the display unit of the PC 20. When the attached IC card 1′ is extracted out, this state is detected, and the identifier read from the IC card 1′ is immediately erased to end the processing.

In specific monitor processing, the virtual token memory service server 3 periodically makes an inquiry as to the connected state of the token (user identification device) with respect to the virtual token driver 2b, and monitors the connected state in accordance with a response from the virtual token driver 2b.

Moreover, the virtual token memory service server 3 specifies the storage position (file storage place) of the data to be used by the virtual token memory corresponding application 6 in accordance with an instruction from the input unit, and the server stores the information of the file storage place together with the corresponding user ID, the user access key and/or the user encryption/decryption key, the application ID, and the application access key and/or the application encryption/decryption key.

Moreover, the virtual token memory service server 3 uniquely derives and produces the user access key and/or the user encryption/decryption key for accessing the data to be used by the virtual token memory corresponding application 6 from the user identifier and the like stored in the IC card 1′; acquires the information of the file storage place by use of the user access key and/or the user encryption/decryption key and the application ID; further decrypts the data stored in the file storage place with the application access key and/or the application encryption/decryption key corresponding to the application ID; and/or accesses the data with the application access key, whereby the data can be used by the virtual token memory corresponding application 6.

Furthermore, the virtual token memory service server 3 encrypts the data used and updated by the virtual token memory corresponding application 6 with the application encryption/decryption key; and/or sets the data to be accessible with the application access key to store the data in the file storage place.

In the above-described present system, the PC 20 has such a constitution as to realize the virtual token memory service server 3, the virtual token memory DB 4, the virtual token memory corresponding client 5 and the virtual token memory corresponding application 6, but it may be considered that the virtual token memory service server 3, the virtual token memory DB 4 and the virtual token memory corresponding client 5 be realized by individual devices. In this case, the devices are connected to the network.

Moreover, the above-described contents of the present system may be realized in the cellular phone 10. Specifically, the processing in the PC 20 is executed by the application which operates in the control unit of the cellular phone 10. Furthermore, the contents of the virtual token memory DB 4 are stored in the storage unit of the cellular phone 10.

In future, owing to enhancement of the function of the cellular phone 10, a capacity of the storage unit (memory) of the cellular phone 10 will increase, and a speed of the processing in the control unit will further be increased. Therefore, it is possible to use various applications in which, for example, the electronic certificate and the like of the IC card 1′ are used.

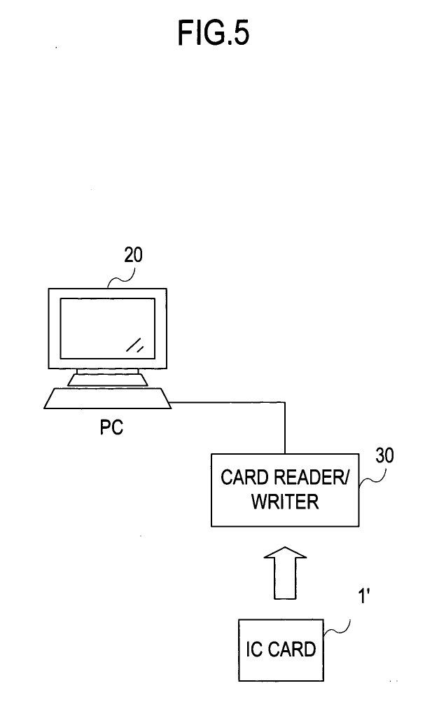

Next, there will be described a user identification infrastructure system in which a general IC card is used in an embodiment of the present invention with reference to FIG. 5. FIG. 5 is a constitution block diagram of the user identification infrastructure system in which an extended storage region can be used with respect to the IC card whose memory is prohibited from being written with data.

The user identification infrastructure system shown in FIG. 5 is basically constituted of an IC card 1′; a card reader/writer 30 which reads the data from the IC card; and a computer (PC) 20 as a processing device connected to the card reader/writer 30.

The user identification infrastructure system of FIG. 5 is different from that of FIG. 2 in that the card reader/writer 30 is provided instead of the cellular phone 10.

Moreover, as the IC card 1′ shown in FIG. 5, an IC card type credit card is considered. When the card reader/writer 30 is provided, the card can be used as a user identification device (token) of the present invention.

It is to be noted that operations of the PC 20 and the card reader/writer 30 are basically similar to the operation of the cellular phone 10, and the system of FIG. 2 can be said to be basically similar to that of FIG. 5.

Other constitution and processing operation of the system of FIG. 2 are basically similar to those of the system of FIG. 5.

Here, the PC 20 includes, for example, a control unit (CPU) which performs a control; a storage unit such as a hard disk (HDD) in which a processing program and user data are stored; an RAM which is a main memory for the operation; a display unit; an input unit such as a keyboard or a mouse; a communication unit which performs communication; and a connecting portion (interface) to be connected to the card reader/writer 30.

Here, the communication unit of the PC 20 may be constituted to be connected to a modem and a public circuit, a LAN, a radio LAN board and the LAN, or a network such as a WAN or Bluetooth (registered trademark).

Moreover, in FIG. 5, the token of the IC card 1′ is connected to the PC 20 via the card reader/writer 30 by a cable, but the PC 20 may be provided with a non-contact card reader/writer using radio, and the IC card 1′ may be connected to the PC 20 by radio.

The storage unit will be described in accordance with an example of an HDD, but there may be considered an FDD, an MO, a removable disk, a nonvolatile memory card or the like.

It is to be noted that when the IC card 1′ is inserted into the card reader/writer 30, the PC 20 can read data (e.g., an identifier stored in an electronic certificate or the like) stored in a nonvolatile memory of the IC card 1′.

This identifier stored in the electronic certificate or the like is a “user identifier” which identifies a user of the IC card 1′. Therefore, there is not any restriction on the identifier as long as the user can be specified, and the electronic certificate does not have to be necessarily used.

When the control unit of the PC 20 operates as the virtual token memory corresponding application 6, a main memory is loaded with a program (application) to operate the program. When the data stored in the extended storage region is used, the control unit operates as the virtual token memory corresponding client 5 to input an ID (identifier for identification) for identification and a password to thereby make a request for the user identification. When the password is appropriate with respect to the ID for identification, and the user identification is OK, the control unit operates as the virtual token memory service server 3 to acquire the identifier stored in, for example, the electronic certificate or the like of the IC card 1′.

It is to be noted that in the user identification, a PIN such as the password may be used, but biological identification may be performed using a fingerprint, a voice pattern, an eye iris or retina, a face image, a blood flow or the like. In this case, each device for the biological identification needs to be mounted on the PC 20.

This PC 20 may be a user's personal computer provided at home or in a user's workplace, or a computer provided in a store where shopping is performed using the IC card.

The IC card reader/writer 30 may be of a contact or non-contact type.

Moreover, if a connecting portion of the IC card reader/writer 30 is distant from that of the PC 20, the IC card reader/writer 30 may be provided with an input device (PIN pad) for exclusive use.

In a case where the user identification infrastructure system of FIG. 2 or 5 has a constitution in which data for biological identification is stored in the virtual storage region of the virtual token memory DB 4, the data for biological identification can be added later, and the user identification system can be extended.

Furthermore, in the user identification infrastructure system of FIG. 2 or 5, when it is detected during the processing that the card has been extracted and the data cannot be read, the virtual token memory service server 3 performs processing to erase the data developed in the main memory. This prevents the data in the main memory from being unnecessarily used.

In the user identification infrastructure system of FIG. 2 or 5, the PC 20 has such a constitution as to realize the virtual token memory service server 3, the virtual token memory DB 4, the virtual token memory corresponding client 5 and the virtual token memory corresponding application 6, but it may be considered that the virtual token memory service server 3, the virtual token memory DB 4 and the virtual token memory corresponding client 5 be realized by individual devices. In this case, the devices are connected to the network. It is also considered that the file storage place of the virtual token memory DB 4 be scattered to further constitute separate databases. In this case, it is considered that the information of the file storage place be designated by a uniform resource locator (URL).

It is to be noted that in the user identification infrastructure system of FIG. 5, a method referred to as EMV specifications which are standard specifications of an IC credit card may be used in mutual identification between the IC card and the virtual token memory service server.

According to the user identification infrastructure system of the embodiment of the present invention, the virtual token memory service server 3 encrypts the information (data) to be used by the application as the extended information with the application encryption/decryption key, and/or sets the information to be accessible with the application access key to store the information in the extended storage region of the virtual token memory DB 4. When a token such as the IC card 1′ is used, the virtual token memory service server 3 produces the user access key and/or the user encryption/decryption key uniquely derived from the user identifier stored in a token such as the IC card 1′; acquires the virtual region management information (the application encryption/decryption key and/or the application access key and the information indicating a place [file storage place] of the virtual storage region) for each user corresponding to the produced user access key and/or user encryption/decryption key and the application ID; reads the encrypted extended information from the place of the virtual storage region; decrypts the information with the application encryption/decryption key; and/or accesses the extended information with the application access key to develop the information in the main memory, whereby the information can be used. Accordingly, the user identification is performed. Moreover, the data to be used by the application can be treated as if the data were the data stored in a token such as the IC card 1′, and large-capacity system can be constituted virtually. The data is encrypted or decrypted with the application encryption/decryption key for each application ID, and/or accessed with the application access key. In consequence, there is an effect that a firewall can be formed for each application.

It is to be noted that in the present embodiment, since a token such as the IC card can secure the virtual storage region, the token can be referred to as the “virtual token”.

Moreover, in the embodiment of the present invention, the data does not have to be directly stored in the IC card. Therefore, even if the usually frequently carried IC card is lost, any important data is not stolen directly from the IC card, which produces an effect that security can be enhanced.

Furthermore, in the embodiment of the present invention, the virtual region management information (the user ID, the user access key and/or the user encryption/decryption key, the application ID, the application access key and/or the application encryption/decryption key and the information of the file storage place) is set for each data corresponding to the application, and encrypted with the application encryption/decryption key, and/or the storage place of the data set to be accessible with the application access key is arbitrarily set. Moreover, there is a restriction on the access by a person other than the user with the user access key and/or the user encryption/decryption key uniquely derived from the user identifier. The only application corresponding to the application ID accesses the file storage place. Therefore, the token can be designed so that the user identification is performed, a plurality of applications can be used with one token, and the virtual region management information on the extended information for use in another application is completely masked. There is an effect that the firewall can be formed between the applications to secure the security.

Furthermore, at this time, since any actual extended information is not stored in a token such as the IC card 1′, the firewall is established for each application, and there is an effect that the securities of the individual data can remarkably be enhanced.

In addition, the extended information stored in the virtual token memory DB 4 is set to be accessible with the application access key for each associated application, and/or encrypted with the application encryption/decryption key. Therefore, for example, even if the extended information is taken out alone, the information cannot be decrypted without the application access key and/or the application encryption/decryption key, and there is an effect that the security can be secured.

Moreover, in the embodiment of the present invention, since the only extended information to be used by the application is read out and decrypted, or encrypted and written, there is an effect that an execution speed of the application can be increased.

Furthermore, in the user identification infrastructure system of the embodiment of the present invention, even if data items to be handled for changing the system on the application side increase, the items can be handled by simply enlarging the extended storage region of the virtual token memory DB 4. Therefore, a file design of the IC card 1′ does not have to be changed as in a conventional art. It is possible to flexibly cope with the system change, and there is an effect that the initial designing of the file can be facilitated.

In addition, when the storage place of the extended information of the virtual token memory DB 4 is changed, the only information of the place of the file in the virtual region management information to be managed by the virtual token memory service server 3 may be rewritten. Since it is possible to cope with the change of the storage place by changing the only data, it is possible to cope with the system change by a simple method, and there is an effect that the initial designing of the file can be facilitated.

According to the present invention, with respect to the application which performs the user identification and which requests the user's data access obtained by the user identification, the storage capacity of the user identification device is virtually flexibly enlarged. When the user identification device is associated with the data stored in the extended storage region for each user and each application, the user identification device can be treated as a virtual user identification device, the application retains independency independently of the individual user identification devices, and the firewall can be formed for each application to secure the security. The present invention is preferable for such a user identification infrastructure system.

What is claimed is:

1. A user identification infrastructure system in which an application operates to perform user identification by use of a user identification device and to request a data access of a user obtained by the user identification, the system comprising:
a virtual memory service server which acquires, from a client, a request for start of the application and identification information of the application and which uses the connected user identification device as a virtual user identification device and which provides an extended storage region with respect to the virtual user identification device and which produces a user access key and/or a user encryption/decryption key uniquely derived from user identification information stored in the user identification device and which accesses and reads data of the user stored in a storage place of the extended storage region specified by the user access key and/or the user encryption/decryption key produced and an identifier of the acquired application.

2. The user identification infrastructure system according to claim 1, wherein the virtual memory service server includes a virtual user identification device driver in which a security level of the user identification is beforehand set to perform the user identification.

3. The user identification infrastructure system according to claim 2, wherein the virtual user identification device driver performs the user identification by a combination of a plurality of user identification devices.

4. The user identification infrastructure system according to claim 1, wherein a virtual user identification device memory database is provided as the extended storage region.

5. The user identification infrastructure system according to claim 4, further comprising:
the client which requests the virtual memory service server to start service, perform the user identification and access the user identification device memory database.

6. The user identification infrastructure system according to claim 1, wherein the virtual memory service server exclusively controls processing of a plurality of applications.

7. The user identification infrastructure system according to claim 5, wherein the virtual memory service server exclusively controls processing of a plurality of applications.

8. The user identification infrastructure system according to claim 1, wherein the virtual memory service server monitors an attached state of the user identification device, and erases the read data, when it is detected that the user identification device is brought into a non-attached state.

9. The user identification infrastructure system according to claim 6, wherein the virtual memory service server monitors an attached state of the user identification device, and erases the read data, when it is detected that the user identification device is brought into a non-attached state.

10. The user identification infrastructure system according to claim 1, wherein the virtual memory service server includes a storage unit in which a user identifier, the user access key and/or the user encryption/decryption key uniquely derived from the user identification information stored in the user identification device, the identifier of the application for use, an application access key and/or an application encryption/decryption key for each application and information of the storage place of related data in the extended storage region are associated with one another and stored,
the related data stored in the extended storage region is encrypted with the application encryption/decryption key, and/or accessed with the application access key and stored, and
when the user identification device is brought into an attached state, the virtual memory service server produces the user access key and/or the user encryption/decryption key uniquely derived from the user identification information stored in the user identification device; acquires the information of the storage place of the related data in the extended storage region based on the user access key and/or the user encryption/decryption key produced and the identifier of the application acquired from the client; reads the related data in accordance with the information of the storage place; decrypts the related data with the corresponding application encryption/decryption key; and/or accesses the related data with the corresponding application access key.

11. The user identification infrastructure system according to claim 10, wherein the related data stored in the extended storage region is encrypted with the corresponding application encryption/decryption key, and/or set to be accessible with the corresponding application access key, and further encrypted with the corresponding user encryption/decryption key, and/or set to be accessible with the user access key and stored, and
to access the related data in the extended storage region, the virtual memory service server decrypts the related data with the corresponding user encryption/decryption key; and/or accesses the related data with the corresponding user access key; further decrypts the related data with the corresponding application encryption/decryption key; and/or accesses the related data with the application access key.

12. The user identification infrastructure system according to claim 11, wherein the related data encrypted with the application encryption/decryption key and/or set to be accessible with the application access key is encrypted using a plurality of user encryption/decryption keys multiple times and stored, and
to access the related data in the extended storage region, the virtual memory service server multi-decrypts the related data by use of a plurality of corresponding user encryption/decryption keys; further decrypts the related data with the corresponding application encryption/decryption key; and/or accesses the related data with the corresponding application access key.

13. The user identification infrastructure system according to claim 8, wherein the identifier of the application, the application access key and/or the application encryption/decryption key and the information of the storage place of the related data in the extended storage region are encrypted with the user encryption/decryption key, and
to access the related data in the extended storage region, the virtual memory service server decrypts the identifier of the application, the application access key and/or the application encryption/decryption key and the information of the storage place of the related data with the user encryption/decryption key; further reads the related data in accordance with the information of the storage place of the decrypted related data; decrypts the related data with the decrypted application encryption/decryption key; and/or accesses the related data with the decrypted application access key.

14. The user identification infrastructure system according to claim 10, wherein the identifier of the application, the application access key and/or the application encryption/decryption key and the information of the storage place of the related data in the extended storage region are encrypted with the user encryption/decryption key, and
to access the related data in the extended storage region, the virtual memory service server decrypts the identifier of the application, the application access key and/or the application encryption/decryption key and the information of the storage place of the related data with the user encryption/decryption key; further reads the related data in accordance with the information of the storage place of the decrypted related data; decrypts the related data with the decrypted application encryption/decryption key; and/or accesses the related data with the decrypted application access key.

15. The user identification infrastructure system according to claim 12, wherein the identifier of the application, the application access key and/or the application encryption/decryption key and the information of the storage place of the related data in the extended storage region are encrypted with the user encryption/decryption key, and
to access the related data in the extended storage region, the virtual memory service server decrypts the identifier of the application, the application access key and/or the application encryption/decryption key and the information of the storage place of the related data with the user encryption/decryption key; further reads the related data in accordance with the information of the storage place of the decrypted related data; decrypts the related data with the decrypted application encryption/decryption key; and/or accesses the related data with the decrypted application access key.

16. The user identification infrastructure system according to claim 1, wherein data of biological identification is encrypted and stored in the storage place of the extended storage region, and
the virtual memory service server reads out the data of the biological identification to decrypt the data, and compares the data with input data of the biological identification to perform the biological identification.

17. The user identification infrastructure system according to claim 10, wherein data of biological identification is encrypted and stored in the storage place of the extended storage region, and
the virtual memory service server reads out the data of the biological identification to decrypt the data, and compares the data with input data of the biological identification to perform the biological identification.

18. The user identification infrastructure system according to claim 13, wherein data of biological identification is encrypted and stored in the storage place of the extended storage region, and
the virtual memory service server reads out the data of the biological identification to decrypt the data, and compares the data with input data of the biological identification to perform the biological identification.
